(19) United States
(12) Patent Application Publication
(10) Pub. No.: US 2008/0211251 A1
(43) Pub. Date: Sep. 4, 2008

(54) WATERBED BEDLINER FOR USE WITH A PICKUP-STYLE VEHICLE

(76) Inventor: Rick Diloreto, Harrison Township, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/041,248

(22) Filed: Mar. 3, 2008

Related U.S. Application Data
(60) Provisional application No. 60/892,273, filed on Mar. 1, 2007.

(51) Int. Cl. B62D 33/02

(52) U.S. Cl. 296/39.2

(57) ABSTRACT

A combination bed liner and fluid retaining unit adapted for mounting within a truck bed in order to selectively ballast the bed. A top cover exhibits a substantially planar base from which extend a pair of sides and an interconnecting rear. A bottom cover exhibits a substantially planar base and a plurality Of upturned side portions overlapping side locations associated with the top. The top and bottom covers are secured together along opposing perimeter locations and in fluid-tight fashion to permit an open interior defined therebetween to be filled with a fluid ballasting medium.

### CROSS-REFERENCE TO RELATED APPLICATIONS

This Application is a Non-Prov of Prov (35 USC 119(e)) application 60/892,273 filed on Mar. 1, 2007 entitled WATERBED BEDLINER FOR USE WITH A PICKUP-STYLE VEHICLE.

### FIELD OF THE INVENTION

The present invention relates generally to a pickup bedliner. More specifically, the present invention teaches a combination bedliner and water retaining/ballasting assembly, such as for weighting the truck bed during cold weather periods associated with snow and ice covered road surfaces.

### BACKGROUND OF THE INVENTION

The prior art is well documented with examples of truck bed ballasting systems which are intended to weight the bed of the truck. The varying objectives of the several prior art ballasting systems is the ability to apply weight to the rear of the truck and in order to compensate for cold weather, with which is normally attributed ice or snow covered road conditions.

A first example of the prior art is disclosed in U.S. Pat. No. 4,796,914, issued to Raynor, and which teaches a hollow compartment firmed in the bottom wall of a truck bed protective liner and defines a ballast chamber to permit inserting liquid ballast in the ballast chamber when it is desired to provide additional weight on the rear portion of the truck and also permitting removal of the liquid ballast from the ballast chamber when it is desired to reduce the weight on the rear portion of the truck. The hollow compartment is provided by spaced apart upper and lower bottom wall members extending the length and width of the protective liner and which is jointed along their front and side edges to the corresponding front and side walls of the liner. A rear wall is joined to the upper and lower bottom walls of the opposed side walls of the liner to completely enclose the ballast chamber.

U.S. Pat. No. 5,080.418, issued to Semple et al., discloses an insert arranged for complementary mounting within a pickup truck bed, the insert including a planar wall construction, with a ribbed top wall to enhance strength and traction of the top wall. The organization defines a central cavity coextensively directed throughout the insert, with a fill plug directed to the top wall and a drain plug directed through and removably mounted relative to the rear wall to permit fluid filling of the cavity to provide weight and enhanced stabilizing of the pickup bed during use of the pickup in reduced traction situations, such as in rain, snow and the like. A modified form of the invention includes apertured spherical shells contained coextensively throughout the cavity to provide fluid balding and minimizing sloshing of water within the pickup bed.

Ryan, III et al., U.S. Patent 2004/0227338 disclose a ballast system for use in a cargo bed of a vehicle for providing generally even weight distribution over rear or powered wheels of the vehicle. The ballast system may be rolled tip into a compact roll during non-use for storage. The ballast system includes a plurality of weighted cross-members laminated, attached, or bonded between two generally pliable mats. The cross members are, preferably, equally spaced apart from each other along width,s of the mats and transverse to a longitudinal direction of the cargo bed of the vehicle.

### SUMMARY OF THE INVENTION

The present invention teaches a two piece and weldable bedliner construction for use in ballasting such as a pickup-style vehicle. The present invention is an improvement over prior art ballast assemblies in that it provides a generally three-dimensional and boxlike assembly which is capable of being installed in a truck bed as a conventional liner, and which also provides the feature of improved and increased fill-ability of a fluid, evenly distributed in baffled fashion through the liner interior and as viewed throughout a welded cross sectional surface area of upper and lower portions of the bedliner.

Additional features include upper located drainage holes to provide overfill protection, combined with conveniently located fill and drainage plugs associated with the top and bottom cover portions, respectively. A top cover exhibits a substantially planar base from which extend a pair of sides and an interconnecting rear. A bottom cover exhibits a substantially planar base and a plurality of upturned side portions overlapping side locations associated with the top. The top and bottom covers are secured together along opposing perimeter locations and in fluid-tight fashion to permit an open interior defined therebetween to be filled with a fluid ballasting medium.

### BRIEF DESCRIPTION OF THE DRAWINGS

Reference will now be made to the attached drawings when read in combination with the following detailed description, wherein like reference numerals refer to like parts throughout the several views, and in which:

FIG. 1 is an elevational view of the waterbed bedliner according to the present inventions:

FIG. 2 is an exploded view of the top and bottom cover portions associated with the bedliner according of the pickup truck bedliner associated with the present inventions;

FIG. 3 is an enlarged cutaway view taken along line 3-3 of FIG. 2 and illustrating the profile of the lengthwise extending channels associated with the top cover portion;

FIG. 3B is a front plan view of the assembled waterbed liner of FIG. 1;

FIG. 3C is a side plan view of the assembled waterbed liner of FIG. 1;

FIG. 4A is a rotated perspective view of the bottom cover portion also illustrated in FIG. 1;

FIG. 4B is an underside plan view o,the bottom cover portion;

FIG. 4C is an enlarged partial top view oft a lower drainage associated with location of the bottom cover portion;

FIG. 4D is a rotated front view of the enlarged partial view of the drain s;own in FIG. 4C associated with a lower location of the bottom cover portion;

FIG. 5 is a further perspective illustration of the bedliner similar that shown in FIG. 1;

FIG. 6 is an enlarged sectional view of a selected bedliner fill plug also shown in FIG. 1;

FIG. 7 is an enlarged and partial exploded view of the top and bottom cover portions of the scale referenced in FIG. 6, and in particular illustrating the mating arrangement established between the side and bottom fluid fill areas;

FIG. 8 is an end cutaway view of top and bottom covers in engaged fashion;

FIG. 9 is an end view cross-sectional cutaway illustration of the waterbed bedliner mounted within a truck bed in a semi-filled configuration; and

FIG. 10 is an overhead assembled illustration of the waterbed liner in partial cutaway and filled with a ballasting fluid.

### DETAILED DESCRIPTION OF THE PREFERRED EMBODIMENTS

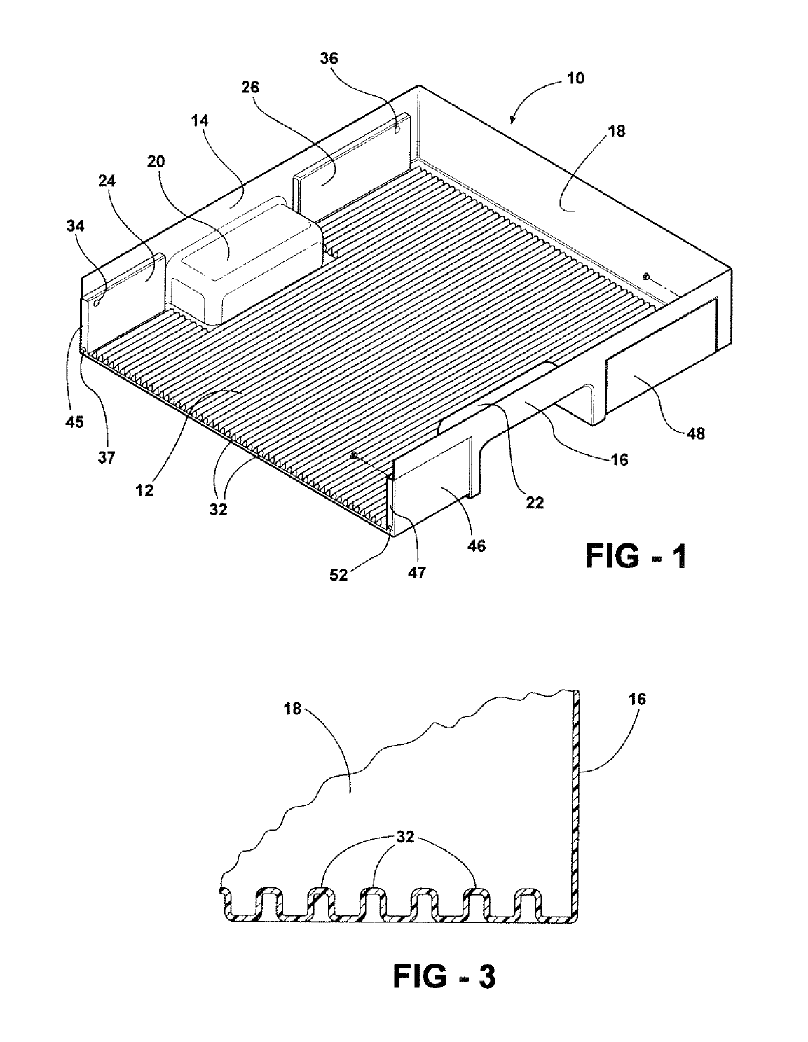

Referring now to FIG. 1, an elevational view is shown at 10 of the waterbed bedliner according to the present invention. As will be discussed with subsequent reference to the several included illustrations, the present invention teaches a two piece and weldable bedliner construction for use in ballasting such as a pickup-style vehicle which is an improvement over prior art ballast assemblies in that it provides a generally three-dimensional and boxlike assembly.

In particular, and referring again to FIG. 1, the assembled bedliner includes a bottom surface 12, first and second sides 14 and 16, a rear extending and interconnecting side 18 and an open forward edge for arriving proximate the tailgate opening of the pickup style vehicle (not shown). The individual sections which comprise the bedliner can be constructed of any suitable material and which can include such as a durable and waterproof polymer construction, as well as a lightweight and durable metal or composite material, such materials exhibiting suitable length, width and thickness dimensions appropriate for sizing and installing in most generally known truck bed configurations.

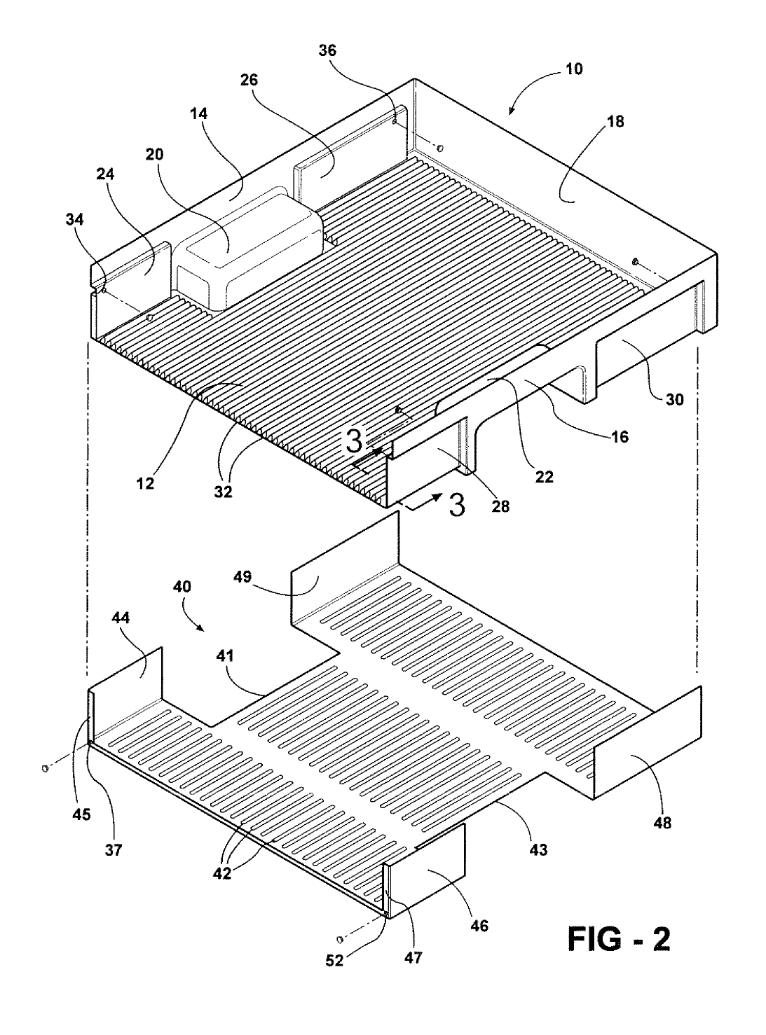

The extending sides 14 and 16 each include wheel well configurations, see at 20 and 22, respectively and, as will be described in additional detail, side disposed fill sections with fill locations (see as best shown in FIG. 2 at 24 & 26 for side 14 and at 28 & 30 for side 16). The fill locations are further referenced by fill caps (as shown at 34 and 36) associated with each of the fill locations 24 & 26 and 28 & 30.

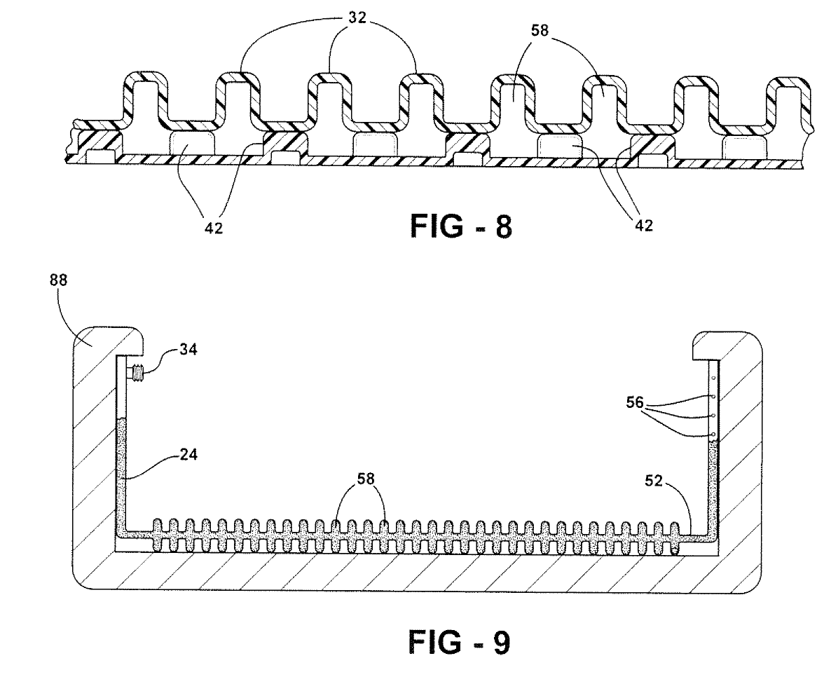

The fill sections communicate with intercommunicating and lengthwise extending baffled channels (at 32 in FIG. 1 and which each define a substantially “U” shaped as viewed in end view cutaway fashion) and which are capable of being installed in a truck bed (generally referenced at 8 in the cutaway view of FIG. 9) as a conventional liner in order to provide the features of improved and increased fill-ability of a fluid, evenly distributed in baffled fashion through the liner interior (i.e. both bottom and sides) and as viewed throughout a welded cross-sectional surface area (see also FIGS. 8 and 9) of upper and lower portions of the bedliner. It is also envisioned that the baffle channels can be alternatively configured in cross sectional profile and to adopt other desired shapes.

Additional features include upper located fluid fill locations, see again at 34 and 36 in FIGS. 1 and 2 for fill cap locations 24 and 26, to provide overfill protection, combined with conveniently located fill plugs and drainage plugs (see also at 37 and 52 in FIGS. 1 and 2), respectively. The inner end interconnecting side 18, as well as the solid wall portions of the sides 14 and 16 not associated with the fill locations 24/26 and 28/30, are also typically of a solid wall construction and are not designed to hold additional volumes of fluid, although this can be achieved through additional design configuration.

Referring to FIG. 2, an exploded view is shown of top 38 and bottom 40 cover portions associated with the bedliner according of the pickup truck bedliner. The features of the top portion 38 are substantially repeated from what is described in FIG. 1. The bottom cover portion 40 is further illustrated in exploded fashion and exhibits a substantially planar shaped bottom (with inwardly recessed sides 41 and 43 associated with seating locations of the vehicle wheel wells corresponding to the upper configurations 20 and 22) and with support ridges 42 defined thereupon, these extending lengthwise in cooperation with the mating baffle channels 32 in the illustrated embodiment (it also being understood that crosswise extending ridges and mating channels can be designed) and as again also illustrated in the end cutaway illustration of FIG. 8.

Additional elements of the bottom 40 cover include upturned side portions, see in FIGS. I and 3 at 44, 46, 48 and 49 which correspond to recess fill cap side locations 24, 26, 28 and 30 associated with the top portion 38. Rear angled side edges are shown at 45 and 47 associated with rear-most located and upturned side portions 44 and 46, upon which are supported the bottom drains 37 and 52.

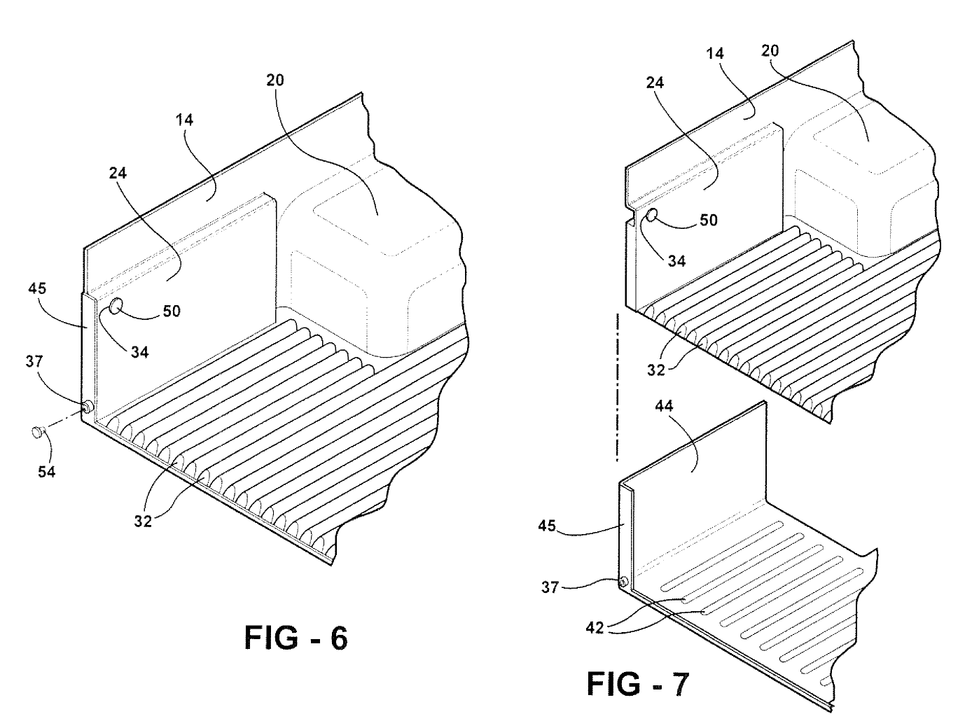

As again are additionally described in reference to FIGS. 6, 7 and 8, the pluralities of support ridges 42 are provided and are associated with an inner face of the bottom cover 40 and are laid out in lengthwise and spaced apart patterns so as to provide crosswise extending, fill channels, and upon being weldingly engaged lo the top cover 38 with the lengthwise extending baffles 32 contacting linearly aligning ridges 42. The top and bottom covers 318 and 40 are further welded about their respective outer perimeters in a fluid retaining and seal-tight fashion. Alternatively, and in the instance of plasticized liner construction vibration welding or other suitable techniques can be employed for fluidly sealing the top and bottom portions,

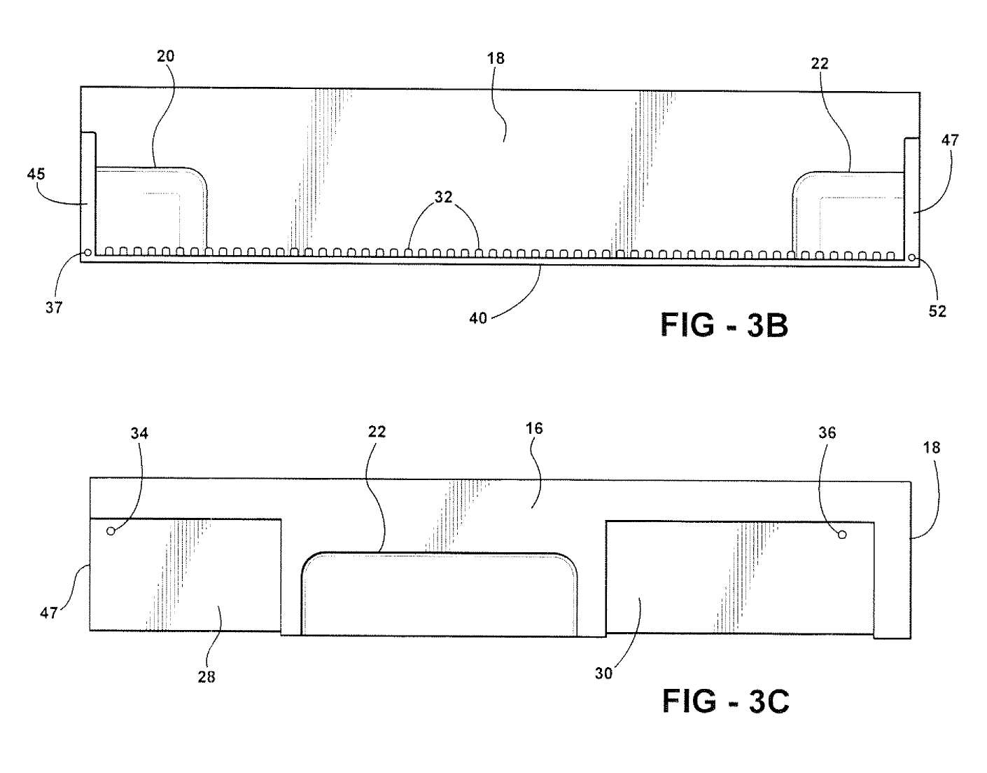

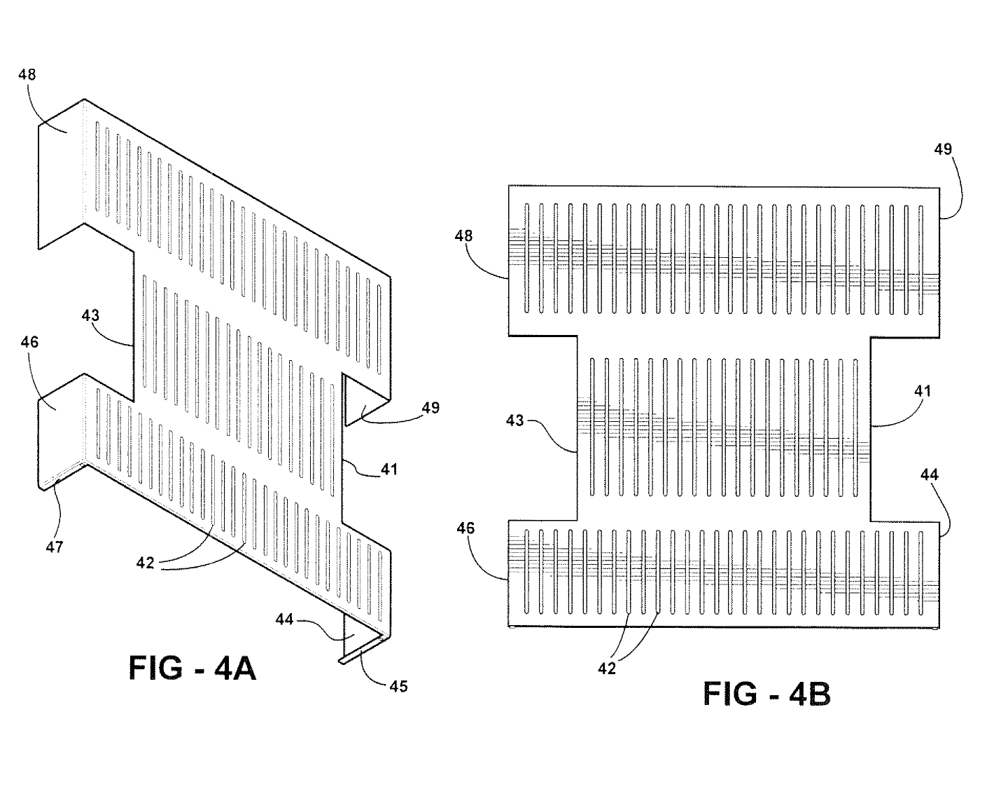

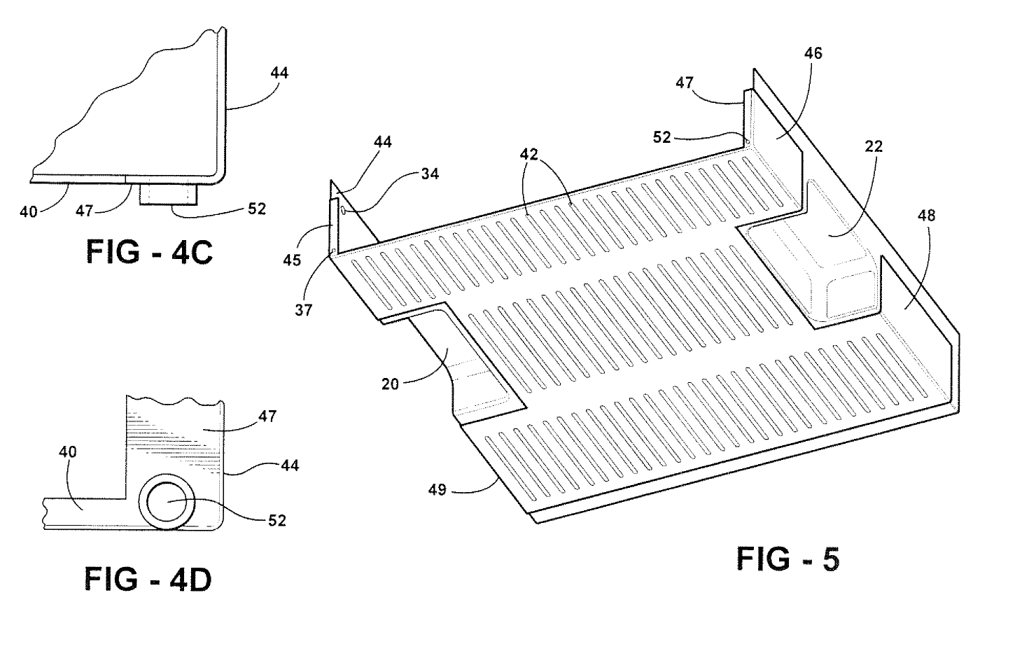

As is also now described in reference to the various illustrations of FIGS. 3 and 4, each of the top and bottom bedliner portions 38 and 40 may again be constructed of a durable and fluid-tight material, including both a lightweight and durable metal as well as potentially a plasticized composition. In the case of metal, aluminum, stainless or otherwise non-corrosive materials is employed and which is welded by conventional means about mating perimeter edges of the top and bottom cover portions. In the further instance of plastic components, sonic welding techniques can be employed for sealing the mating edges of the cover portions.

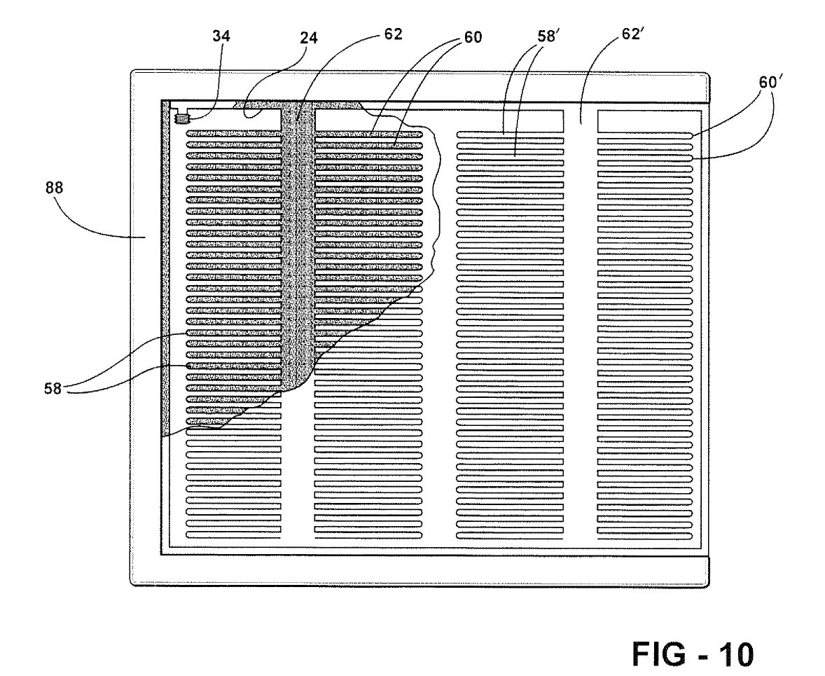

FIGS. 3, 3B and 3C present a series of two-dimensional and cutaway illustrations associated with the top cover portion 38 of the pickup truck bedliner also previously described in FIGS. 1 and 2. Of note, the corrugated shape of the lengthwise extending baffled channels 32 in combination with the support ridges 42 is better illustrated, these being fluidly interconnected in spaced apart banks or sections (as will be further described with reference to the cutaway illustration of FIG. 10 and which are intercommunicated by the crosswise extending fill channels). It is also envisioned that lengthwise baffle channels may also be interconnected in end-to-end communicating fashion, this however increasing the time for filling the unit with the desired volume of water or other fluid (e.g. perhaps a glycol based solution which will not freeze in extreme cold).

The configuration of the side disposed fill sections with fill cap locations (see again at 24 & 26 for side 14 and at 28 & 30 for side 16) is also referenced and which are inwardly recessed relative to the associated sides 14 and 16 to provide for mating engagement of the overlapping and upturned side portions (see again by example at 44, 46, 48) associated with the bottom cover 40. These are again further illustrated in the series of illustrations set forth in FIGS. 1, 4A, 4B and 5, and which show a series of perspective, two-dimensional and cutaway illustrations associated with the bottom cover portion 40. Illustrated in additional detail is the spaced apart and linearly extending arrangement of the support ridges 42 for overlapping the baffled channels 32 and in order to define the appropriate fluid fill configuration (see also again FIG. 10).

Referencing further FIGS. 6 and 7 in cooperation, enlarged perspective and exploded views are shown of the bedliner and which provides multiple fill plug locations, Specifically, and as best shown in FIG. 6, selected side fill location 34 is illustrated and which includes an associated fill cap 50. Also illustrated is a drain location, see again at 37, positioned at a lowermost rear facing location of the side till panel 24 (as is a corresponding drain location 52 for the opposing panel 28 associated with side 16) and which is accessible typically through opening the truck tailgate. A drain plug, see at 54 in FIG. 6, is further provided in cooperation with each of the rear fill locations 24 and 28 on opposite sides of the truck bed and in order to provide quicker emptying of the fluid ballasting contents.

Additional features shown include the enlarged partial edge view of the top cover in FIG. 7 and by which the configuration of the baffle channels 32 are illustrated from another perspective. FIGS. 6 and 7 again shows a further partial illustration of a plurality of support ridges 42 associated with an inner face of the bottom cover 40 again arranged in opposing fashion relative to a welded top cover 38 which displays the lengthwise extending baffle channels 32 (also illustrated in end cutaway of FIG. 8).

The lengthwise engagement of the baffle channels 32 with the segmented and likewise length extending ridge supports 42 define therebetween the lengthwise and interconnecting widthwise channels (referencing again the overhead illustrations of FIG. 10) for facilitating tilting of the ballasting bedliner 10 in the fashion previously described. The mating and inter-communicating nature of the baffle channel to support ridge architecture is complementary illustrated in FIGS. 8-10 by rows of branching channels 58 and 60 intercommunicated by common and crosswise extending fill trunk or channel 62. As further most clearly shown in FIG. 10, multiple crosswise fill channels and branching/perpendicular channels are referenced by additional fill channel 62′ and opposite extending branching channels 58′ and 60′.

Referring finally to the illustration of FIG. 9, a side cutaway tilling configuration is shown in cross section for the waterbed bedliner according to the present inventions. As is also shown in the overhead view of FIG. 10, a threaded fill nozzle 34 is illustrated (this corresponding to the fill location generally shown at 34 in FIG. 1 and corresponding to the three-dimensional fill panel location 24). Although not clearly shown, it is understood that an appropriate cover cap or, alternatively, and on/off valve built into the nozzle 34 can also be provided and to prevent inadvertent leaking of fluid during use of the vehicle.

Further, and in particular referencing the illustration of FIG. 9, additional drain holes are shown 56, these preventing overfilling of water, thereby also allowing room for expansion of the fluid (e.g. typically water and/or a glycol based solution). The configuration of the drain holes 56 may also be substituted by other drainage features which are contemplated, the provision of which is intended to prevent overfilling, and thereby damage to the unit, resulting from the expansion of thermally affected/freezing fluid.

The configuration and sizing of the unit are susceptible to change within the scope of the invention, however potential variants contemplate storage capabilities, in an example of 13.76 gallons, which at 8.33 lbs/gallon weight equals 114 lbs. A further and larger example contemplates an 18 fluid gallon capacity of water, this equating to 150 lbs of distributed and ballasting support across the truck bed. Typical truck bed liners average 5′×6′×1″ in unit size (again based upon the design particulars of the specific vehicle for which the unit is sized) and which in the example cited above would equate an interior fluid holding volume of approximately 4320 cubic inches.

Having described my invention other and additional preferred embodiments will become apparent to those skilled in the art to which it pertains and without deviating from the scope of the appended claims.

I claim:

1. A combination bed liner and fluid retaining unit adapted for mounting within a truck bed in order to selectively ballast the bed, said unit comprising:
a top cover exhibiting a substantially planar base from which extend a pair of sides and an interconnecting rear;
a bottom cover exhibiting a substantially planar base and a plurality of upturned side portions overlapping side locations associated with said top; and
said top and bottom covers being secured together along opposing perimeter locations and in fluid-tight fashion to permit an open interior defined therebetween to be filled with a fluid medium.

2. The bed liner as described in claim 1, said top cover further comprising a plurality of lengthwise extending and parallel spaced baffle channels, each exhibiting, a substantially “U” shape in cross section.

3. The bed liner as described in claim 2, said bottom cover further comprising at least one plurality of lengthwise extending and segmented support ridges, said baffle channels contacting said support ridges and further defining, therebetween, fill channels extending crosswise relative to said linearly extending baffle channels.

4. The bed liner as described in claim 1, said top exhibiting a specified shape and size and further comprising side disposed fill panel locations, at least one of said fill panel locations further comprising a reclosable fill cap.

5. The bed liner as described in claim 4, said upturned side portions associated with said bottom cover being sized so as to overlap and matingly engage said side disposed fill panels to support additional volumes of fluid.

6. The bed liner as described in claim 4, further comprising at least one drain having a reclosable drain plug and in a location associated with said bottom cover proximate a rear tailgate location of the truck bed.

7. The bed liner as described in claim 4, further comprising a threaded nozzle attachment capable of being secured to at least one of said fill panels.

8. The bed liner as described in claim 5, further comprising a plurality of upper disposed drain holes associated with said sides of said top cover and to prevent overfilling of said unit.

9. The bed liner as described in claim 1, each of said top and bottom cover portions being constructed of a durable plasticized material which is sonically welded about associated perimeters thereof.

10. A combination bed liner and fluid retaining unit adapted for mounting within a truck bed in order to selectively ballast the bed, said unit comprising:
a top cover exhibiting a substantially planar base from which extend a pair of sides and an interconnecting rear said top cover further comprising side disposed fill panel locations, at least one of said till panel locations further comprising a reclosable fill cap, said top cover further comprising a plurality of lengthwise extending and parallel spaced baffle channels, each exhibiting a substantially “U” shape in cross section;
a bottom cover exhibiting a substantially planar base and a plurality of upturned side portions overlapping side locations associated with said top, said bottom cover further comprising at least one plurality of lengthwise extending and segmented support ridges, said baffle channels contacting said support ridges and further defining, therebetween, fill channels extending crosswise relative to said linearly extending baffle channels, said upturned side portions associated with said bottom cover being sized so as to overlap and matingly engage said side disposed fill panels to support additional volumes of fluid;
at least one drain having a reclosable drain plug defined in said bottom cover proximate a rear tailgate location of the truck bed; and
said top and bottom covers being secured together along opposing perimeter locations and in fluid-tight fashsion to permit an open interior defined therebetween to be filled with a fluid medium.

11. The bed liner as described in claim 10, further comprising a threaded nozzle attachment capable of being secured to at least one of said fill panels.

12. The bed liner as described in claim 10, further comprising a plurality of upper disposed drain holes associated with said sides of said top cover and to prevent overfilling of said unit.

13. The bed liner as described in claim 14, each of said top and bottom cover portions being constructed of a durable plasticized material which is sonically welded about associated perimeters thereof.

14. A combination bed liner and fluid retaining unit supported upon a truck bed in order to selectively ballast the truck bed, said unit comprising:
a top cover exhibiting a substantially planar base from which extend a pair of sides and an interconnecting rear! said sides each further include a wheel well configuration, said top further comprising a plurality of lengthwise extending and parallel spaced baffle channels:
a bottom cover exhibiting a substantially planar base and a plurality of upturned side portions overlapping side locations associated with said top, opposite and inwardly recessed sides being defined in said bottom cover and corresponding with the locations of the wheel wells defined in said top cover; and
said top and bottom covers being secured together along opposite perimeter locations and in fluid-tight fashion to permit an open interior defined therebetween to be filled with a fluid medium.

15. The bed liner as described in claim 14, said bottom cover further comprising at least one plurality of lengthwise extending and segmented support ridges, said baffle channels contacting said support ridges and further defining therebetween, fill channels extending crosswise relative to said linearly extending baffle channels.

16. The bed liner as described in claim 14, said top exhibiting a specified shape and size and further comprising side disposed fill panel locations, at least one of said fill panel locations further comprising a reclosable fills cap, said upturned side portions associated with said bottom cover being sized so as to overlap and matingly engage said side disposed fill panel locations to support additional volumes of fluid.

17. The bed liner as described in claim 16, further comprising at least one drain having a reclosable drain plug and in a location associated with said bottom cover proximate a rear tailgate location of the truck bed.

18. The bed liner as described in claim 16, further comprising a threaded nozzle attachment capable of being secured to at least one of said fill panels.

19. The bed liner as described in claim 18, further comprising a plurality of upper disposed drain holes associated with said sides of said top cover and to prevent overfilling of said unit.

20. The bed liner as described in claim 14, each of said top and bottom cover portions being constructed of a durable plasticized material which is sonically welded about associated per meters thereof.
